(19) United States
(12) Patent Application Publication
(10) Pub. No.: US 2011/0198885 A1
(43) Pub. Date: Aug. 18, 2011

(54) VEHICLE WITH AT LEAST ONE FLOW INFLUENCING ELEMENT WITH A SPOILER EDGE AND METHOD FOR INFLUENCING AN AERODYNAMIC DRAG OF A VEHICLE

(75) Inventors: Borris ILSE, Mainz (DE); Boris JACOB, Wiesbaden (DE); Nicolas KRUSE, Mainz (DE); Bertrand BACH, Wiesbaden (DE); Ulrich BAUER, Mainz (DE)

(73) Assignee: GM GLOBAL TECHNOLOGY OPERATIONS LLC, Detroit, MI (US)

(21) Appl. No.: 13/029,688

(22) Filed: Feb. 17, 2011

(30) Foreign Application Priority Data
Feb. 17, 2010 (DE) 102010008332.1

(51) Int. Cl. B62D 37/02

(52) U.S. Cl. 296/180.5

(57) ABSTRACT

A vehicle includes, but is not limited to at least one flow influencing element with a spoiler edge arranged in a lateral rear region of the vehicle. The flow influencing element has a first position, in which the spoiler edge is substantially concealed by a body element and a second position, in which the spoiler edge is substantially exposed.

### CROSS-REFERENCE TO RELATED APPLICATION

This application claims priority to German Patent Application No. 102010008332.1, filed Feb. 17, 2011, which is incorporated herein by reference in its entirety.

### TECHNICAL FIELD

The technical field relates to a vehicle with at least one flow influencing element with a spoiler edge arranged in a lateral rear region of the vehicle. In addition, the technical field relates to a method for influencing an aerodynamic drag of a vehicle.

### BACKGROUND

From DE 199 12 140 C2 flow influencing elements for reducing the aerodynamic drag of a vehicle are known, which for example can be attached in the rear region and which can be periodically moved so that time-dependent disturbances can be introduced into the air stream flow in a defined manner. Although such flow influencing elements are suitable for reducing the aerodynamic drag of a vehicle, they also constitute expensive attachments to the vehicle and additionally spoil the appearance of the vehicle.

When designing the vehicle outer skin and contour, technical aspects are important but aesthetic considerations likewise play a major part. For example, relatively round and soft contours are currently more in fashion and demand than sharp edges, which from an aerodynamic point of view would frequently be more advantageous.

In view of the foregoing, at least one object is to provide a vehicle comprising a favourable aerodynamic drag on the one hand but on the other hand preferably leaves plenty of design freedom in its exterior design. In addition at least a further object is to provide a method for the specific influencing of the aerodynamic drag of a vehicle. Furthermore, other objects, desirable features and characteristics will become apparent from the subsequent summary and detailed description, and the appended claims, taken in conjunction with the accompanying drawings and this background.

### SUMMARY

According to an embodiment, a vehicle comprises at least one flow influencing element with a spoiler edge arranged in a lateral rear region of the vehicle, wherein the flow influencing element comprises a first position, in which the spoiler edge is substantially concealed by a body element and a second position, in which the spoiler edge is exposed.

Here and in the following a flow influencing element is to mean an element whose object is the specific influencing of the air circulating around the vehicle in motion. A spoiler edge in this case and in the following is to mean an edge of the flow influencing element which is designed in such a manner that the air flow separates from the edge at least from a predetermined speed.

The vehicle has at least the advantage that the flow influencing element in its first position is concealed and thus not visible, while in its second position it favourably influences the aerodynamics of the vehicle. Accordingly it is possible to move the flow influencing element into the second position and thus render it visible only when at a relatively high speed it is needed or is advantageous for technical reasons. The vehicle and particularly its rear region can be advantageously designed under aesthetic aspects since a spoiler edge for the air flow is made available if required by the flow influencing element.

In an embodiment the at least one flow influencing element can be pivoted between the first and the second position. Alternatively, the at least one flow influencing element can be shifted between the first and the second position and through moving in a direction substantially parallel to the vehicle outer skin can be moved between the first position and the second position. A movement substantially parallel to the vehicle outer skin in this case means a movement in a direction that deviates from that of the vehicle outer skin in the region of the flow influencing element by not more than approximately 10 degrees. At any rate, it deviates from the direction of the vehicle outer skin only to the extent that the flow influencing element is substantially moved parallel to the air flow, which is no substantial force, is exerted on the flow influencing element by the air flow that could influence its movement.

Such an arrangement has the advantage that a movement of the flow influencing element between the positions is also possible without problems at high speeds since only a substantially linear movement parallel to the driving direction and thus to the flow direction is required. In addition, the movement mechanism can be designed very simply and sturdily and does not require any joints.

In an embodiment the at least one flow influencing element is arranged in a first position in a slit in the vehicle outer skin. In another embodiment a flow influencing element with a spoiler edge is arranged in the right lateral rear region as well as in the left lateral rear region. In another embodiment the at least one flow influencing element can be moved between the first and the second position as a function of the vehicle speed.

With a method for influencing an aerodynamic drag of a vehicle according to an embodiment, at least one flow influencing element with a spoiler edge arranged in a lateral rear region of the vehicle is moved as a function of the vehicle speed between a first position, in which the spoiler edge is substantially concealed by a body element and a second position, in which the spoiler edge is exposed.

Here, the at least one flow influencing element can be more preferably moved into the second position when the vehicle speed exceeds a predetermined threshold value. This threshold value is advantageously based on the aerodynamic behaviour of the vehicle. At higher speeds, such as for example occur when travelling on a motorway, the importance of a spoiler edge in the rear region grows increasingly so that a suitable threshold value for example could be approximately 80 km/h, however at least between approximately 70 and approximately 100 km/h.

In an embodiment the at least one flow influencing element is moved into the second position when the vehicle speed exceeds the predetermined threshold value at least for a predetermined time span. With this embodiment, the flow influencing element is only activated when an extended trip with high speed, for example on a motorway, can be expected. In another embodiment the at least one flow influencing element is moved into the second position as a function of the position of the vehicle. With this embodiment, too, the flow influencing element is only activated when for example a trip on the motorway has been established. The position of the vehicle can more preferably be determined by means of satellite-backed navigation. A further possible criterion for moving the flow influencing element into the second position is the acceleration of the vehicle.

For the movement back into the first position the mentioned criteria can apply conversely, while the flow influencing element is moved into the first position when because of the current speed below the threshold value and/or the time span during which driving is at low speed and/or because of the position and/or the acceleration it is established that the aerodynamic behaviour of the vehicle advantageous at high speeds is no longer necessary.

The at least one flow influencing element can be pivoted or shifted between the first and the second position. In an embodiment it is moved between the first position and the second position through moving in a direction substantially parallel to the vehicle outer skin.

### BRIEF DESCRIPTION OF THE DRAWINGS

The embodiments will hereinafter be described in conjunction with the following drawing figures, wherein like numerals denote like elements, and

FIG. 1 schematically shows a vehicle with flow influencing elements according to an embodiment;

FIG. 2 schematically shows a detail from the vehicle according to FIG. 1 with a flow influencing element in a first position; and

FIG. 3 schematically shows a detail from the vehicle according to FIG. 1 with a flow influencing element in a second position.

### DETAILED DESCRIPTION

The following detailed description is merely exemplary in nature and is not intended to limit application and uses. Furthermore, there is no intention to be bound by any theory presented in the preceding background or summary or the following detailed description.

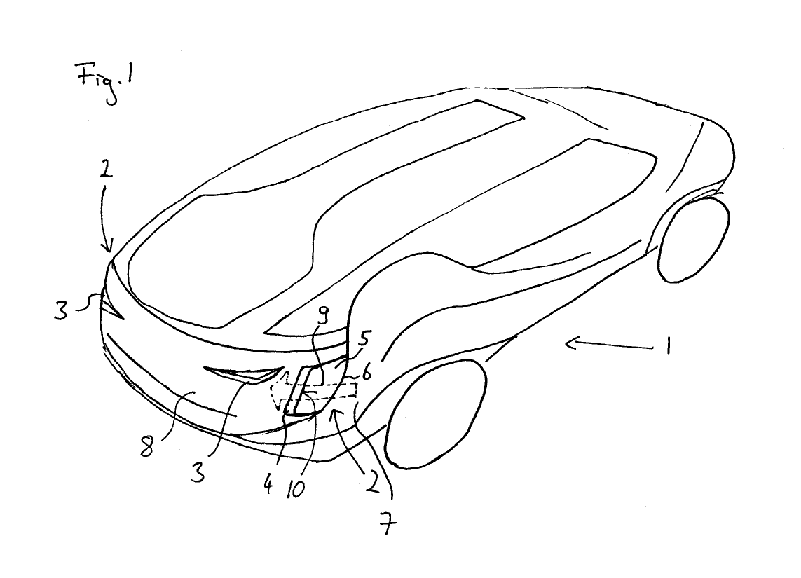

The vehicle 1 according to FIG. 1 on the whole and more preferably in its rear region 8 comprises rounded shapes. To the right and left flow influencing elements 5 with spoiler edges 10 are provided in lateral rear regions 2 in the region in front of the rear lights 3. To this end, depressions 4 in which the flow influencing element 5 can slide are arranged on each side in the lateral rear region 2.

The flow influencing elements 5 are designed as fins which can be shifted parallel to the direction of the vehicle outer skin illustrated by the arrow 9. To receive the flow influencing elements 5 a slit 6 each is provided. Flow influencing elements 5 received in the slit 6 are entirely or partially concealed by the body element 7.

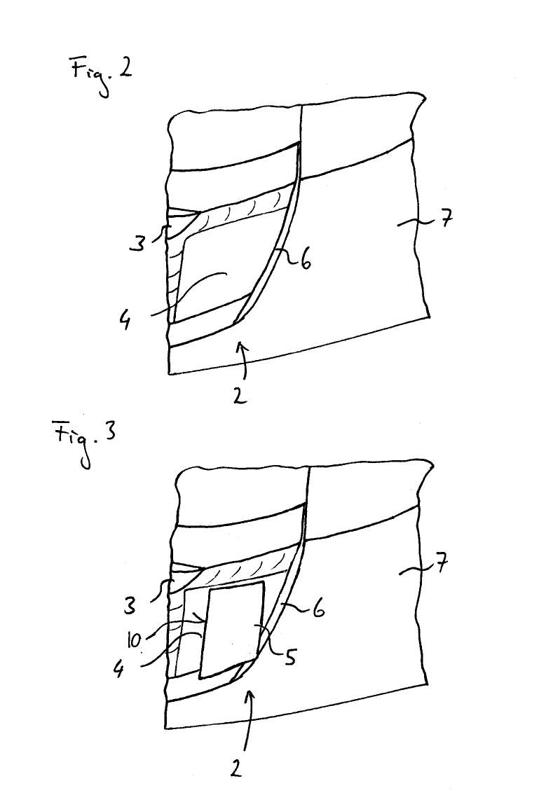

FIG. 2 schematically 2 shows a detail from the vehicle 1 according to FIG. 1 with a flow influencing element 5 in a first position. In the first position the flow influencing element 5 is completely pushed into the slit 6 and concealed by the body element 7.

FIG. 3 schematically shows a detail from the vehicle 1 according to FIG. 1 with a flow influencing element 5 in a second position. In the second position, the flow influencing element 5 is extended and the spoiler edge 10 is effective on the outer skin of the vehicle 1 for separating the air flow circulating about the vehicle 1. The flow influencing element 5 can also assume intermediate positions between the first position and the second position and merely be partially extended, as a result of which the position of the spoiler edge 10 changes with respect to the vehicle 1.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A vehicle, comprising:
a lateral rear region;
a flow influencing element with a spoiler edge arranged in the lateral rear region; and
a body element,
wherein the flow influencing element has a first position in which the body element substantially conceals the spoiler edge and a second position in which the spoiler edge is substantially exposed.

2. The vehicle according to claim 1, wherein the flow influencing element is configured to pivot between the first position and the second position.

3. The vehicle according to claim 1, wherein the flow influencing element is configured to shift between the first position and the second position.

4. The vehicle according to claim 1, wherein the flow influencing element in the first position is arranged in a slit in an outer skin of the vehicle.

5. The vehicle according to claim 4, wherein the flow influencing element is configured to move between the first position and the second position in a direction substantially parallel to the outer skin.

6. The vehicle according to claim 1, wherein the lateral rear region comprises a right lateral rear region, a left lateral rear region comprising the flow influencing element and the right lateral rear region comprising a second flow influencing element.

7. The vehicle according to claim 1, wherein the flow influencing element is configured to move between the first position and the second position as a function of a speed of the vehicle.

8. A method for influencing an aerodynamic drag of a vehicle, comprising:
determining a parameter of the vehicle; and
moving a flow influencing element with a spoiler edge arranged in a lateral rear region of the vehicle as a function of the parameter between a first position in which the spoiler edge is substantially concealed by a body element and a second position in which the spoiler edge is substantially exposed.

9. The method according to claim 8,
wherein the parameter is a speed of the vehicle, and
wherein the moving the flow influencing element comprises moving the flow influencing element into the second position when the speed exceeds a predetermined threshold value.

10. The method according to claim 8,
wherein the parameter is a speed of the vehicle, and
wherein the moving the flow influencing element comprises moving the flow influencing element into the second position when the speed exceeds a predetermined threshold value at least for a predetermined period.

11. The method according to claim 8, wherein the parameter is a position of the vehicle.

12. The method according to claim 8, wherein the parameter is an acceleration of the vehicle.

13. The method according to claim 8, wherein the moving the flow influencing element comprises pivoting the flow influencing element between the first position and the second position.

14. The method according to claim 8, wherein the moving the flow influencing element comprises shifting the flow influencing element between the first position and the second position.

15. The method according to claim 8, wherein the moving the flow influencing element comprises moving the flow influencing element in a direction substantially parallel to an outer skin of the vehicle.
